(19) United States
(12) Patent Application Publication
(10) Pub. No.: US 2021/0043099 A1
(43) Pub. Date: Feb. 11, 2021

(54) ACHIEVING LONG TERM GOALS USING A COMBINATION OF ARTIFICIAL INTELLIGENCE BASED PERSONAL ASSISTANTS AND HUMAN ASSISTANTS

(71) Applicants: Shenggang Du, Glendale, CA (US); Guoguo Chen, Kirkland, WA (US)

(72) Inventors: Shenggang Du, Glendale, CA (US); Guoguo Chen, Kirkland, WA (US)

(21) Appl. No.: 16/987,238

(22) Filed: Aug. 6, 2020

Related U.S. Application Data
(60) Provisional application No. 62/884,075, filed on Aug. 7, 2019.

(51) Int. Cl. G09B 5/14; G09B 5/12; G06N 20/00; G06F 16/9032; G06F 9/451

(52) U.S. Cl. CPC G09B 5/14; G09B 5/12; G06F 9/453; G06F 16/90332; G06N 20/00

(57) ABSTRACT

An apparatus, system, and method is disclosed for a hybrid approach to using AI agents and human agents to provide behavioral coaching. Hybrid modes of coaching are supported in which conversations can be handed off from AI agents to human agents. In some implementations, collaborate modes of coaching are supported in which a human agent collaborates with an AI agent.

### CROSS-REFERENCE TO RELATED APPLICATIONS

This application claims priority to U.S. Provisional Application Ser. No. 62/884,075, filed Aug. 7, 2019, titled “System and Methods for Achieving Long-Term Goals Using an Artificial Intelligence Based Personal Assistant”, which is hereby incorporated herein in its entirety by this reference.

### FIELD OF THE INVENTION

The present disclosure generally relates to using Artificial Intelligence (AI) agents and human agents to help coach users to achieve goals, such as improvements in health-related behavior.

### BACKGROUND

There is increasing interest in preventive health care in which users implement lifestyle changes to reduce risk factors for the onset, progression, or severity of certain diseases. For example, a healthier diet, a regular exercise program, improved sleep, and stress management may reduce the risk factors for the onset, progression, or severity of specific diseases.

As a few examples, some health conditions, such as pre-diabetes or early-stage diabetes, can benefit from lifestyle changes in regards to diet, exercise, and losing weight. However, many people find it difficult to implement lifestyle changes.

Consequently, many people benefit from behavior-modification based coaching to aid in implementing changes to diet, exercise, stress management, or other lifestyle changes. There are currently two primary approaches (paradigms) for using network technology to help people achieve long-term goals. However, each of these approaches has various drawbacks.

The first common approach is a digital platform connecting a user and human agent(s) such as a health coach, dietitian, or diabetes educator. The platform enables the user and human agent to “chat” or otherwise communicate. Thus, in this approach, a human agent is responsible for chatting with users. The human agent sends messages to a user, although in some cases the human user may have some predefined response messages that they can select from to make their work more efficient.

The second common approach is to use an automated chatbot to communicate with a user. In this approach, the automated chatbot is in a closed environment that allows a user to select a predefined (prepopulated) response tab to continue a conversation. This has the disadvantage of being limited to a “script” or a small set of possible responses, and hence is unrealistic or unproductive for many situations. It also lacks the less constrained environment and flexible (“say anything”) nature that is typical to (and desired of) many user interactions with a human coach. The constrains of the user inputs make it impossible for the chatbot to “listen” to the user's needs and thus unable to learn from it.

Current methods of using human agents to assist users in achieving behavioral changes have a limited ability to affect behavior as a result of their infrequent and inadequate monitoring of a user's daily life and activities. For example, a coaching service may have practical limitations on the number of human agents available to help users due to cost issues, the time and cost to train human agents, and scheduling issues for the human agents.

It is very difficult to scale up a coaching service while providing the coaching service at a reasonable price and within a reasonable consistent range of quality in terms of results and the user experience. For example, some behavior-based coaching services directed to helping users achieve weight loss goals have been criticized for providing an inconsistent quality of coaching services. Additionally, these same services sometimes don't meet user expectations in terms of the overall quality of the coaching services.

Simple chatbots can be scaled up to handle large volumes of interactions. However, a conventional chatbot typically only allows users to select from a set of fixed responses that may not satisfactorily address a user's short-term and long-term goals. A conventional chatbot doesn't adapt to individual needs. Additionally, a conventional chatbot may have difficulty adapting to unusual circumstances.

There are thus no satisfactory solutions to use technology to scale up behavior-based coaching. Embodiments of the invention are directed toward solving these and other problems individually and collectively.

### SUMMARY

The present disclosure relates to providing behavioral coaching services using a hybrid combination of AI agents and human agents. The AI agents help to provide scalability of the platform. The human agents can be drawn in to handle coaching conversations to maintain the quality of the coaching service within a desired level of quality, such as when there is a risk an AI agent may fail to provide a satisfactory coaching experience. Various risk factors may be considered, such as a conversation risk and a goal risk.

An example of a computer-implemented system includes AI agents trained to provide behavioral modification coaching sessions that include interactive coaching conversations with a human user. A sensing system is configured to monitor coaching conversations conducted by AI agents and evaluate risk factors related to maintaining a quality of the coaching sessions within a pre-selected range of quality. The sensing system may use semantic analysis, sentiment analysis, or other approaches to monitor risk factors within a coaching conversation and a series of coaching conversations. A decision system evaluates the risk factors and schedules a human agent coach to handle a conversation session in response to detecting a quality of a coaching session falling below the pre-selected range of quality. In some implementations, one or more risk factor scores are generated and the scores are used to make conversation decisions for a human agent to handle a conversation examples. Some examples include transferring a conversation to a human agent or scheduling a collaborative coaching session in which a human agent works in collaboration with an AI agent to service a coaching conversation. In some implementations, additional modes of operation including making decisions to transfer a conversation from a first type of AI agent to a second type of AI agent better suited to handling a coaching conversation.

The system and method can be adapted to consider a wide variety of factors in making conversation decisions. These include a variety of factors specifically related to taking into account special considerations that arise in a behavioral coaching environment in which there may be a number of different coaching sessions used to aid a user to achieve short-term goals and tasks that are part of a long-term goal.

It should be understood, however, that this list of features and advantages is not all-inclusive and many additional features and advantages are contemplated and fall within the scope of the present disclosure. Moreover, it should be understood that the language used in the present disclosure has been principally selected for readability and instructional purposes, and not to limit the scope of the subject matter disclosed herein.

### BRIEF DESCRIPTION OF THE DRAWINGS

The present disclosure is illustrated by way of example, and not by way of limitation in the figures of the accompanying drawings in which like reference numerals are used to refer to similar elements. Embodiments of the disclosure will be described with reference to the drawings, in which:

FIG. 1 is a diagram illustrating a system for assisting a user to achieve a longer-term goal using AI driven agents and human agents in accordance with an implementation;

FIG. 2 is a diagram of a server based implementation in accordance with an implementation.

FIG. 3 is a high-level flowchart of a method of transferring a conversation from an AI agent to a human agent based on risk factors according to an implementation.

FIG. 4 is a high level flow chart of a method of scheduling a collaborative coaching conversation in accordance with an implementation.

FIG. 5 is a high level flow chart of a method of scheduling a handover of a coaching conversation between different types of AI agents in accordance with an implementation.

FIG. 6 is a high level flow chart of a method of identifying and selecting risk factors in accordance with an implementation.

FIG. 7 is a high level flow chart of a method of training a ML model to evaluate risk factor score for a conversation decision in accordance with an implementation.

FIG. 8 is a high level flow chart of a method of generating reports and recommendations in accordance with an implementation.

FIG. 9 illustrates a method of determining how to match a user with an AI agent in accordance with an implementation.

FIG. 10 illustrates a method of selecting an AI agent using a machine learning approach in accordance with an implementation.

FIG. 11 illustrates a method of calculating a conversation risk in accordance with an implementation.

FIG. 12 illustrates a method of calculating a goal achievement risk in accordance with an implementation.

FIG. 13 illustrates a method of using an overall risk score, relevance to short term goals, workload of agents, and active user to make decisions to transfer conversations to human agents in accordance with an implementation.

FIG. 14 illustrates a method of calculating a conversation risk score in accordance with an implementation.

FIG. 15 illustrates a method of calculating a goal risk score in accordance with an implementation.

FIG. 16 illustrates a method of calculating an overall risk score in accordance with an implementation.

FIG. 17 illustrates a method of calculating an overall risk score in accordance with an implementation.

FIG. 18 illustrates a method of selecting a human agent in accordance with an implementation.

### DETAILED DESCRIPTION

Embodiments of the disclosure are directed to systems, apparatuses, and methods for more effectively assisting a user to achieve a long-term goal, such as a behavioral change, using a combination of AI agents and human agents. In some implementations, the behavioral change is related to making behavioral changes related to health or fitness.

Embodiments of the systems, methods, and apparatuses described herein provide an AI supplemented personal assistant to enable more efficient and effective achievement of long-term goals. The AI driven personal assistant is integrated with the capability of automatic human agent intervention. The system comprises at least one device (e.g., a smartphone, laptop, tablet, etc.) that allows a user to conduct conversations, an AI agent, human agent(s) platform hosted on one or more servers, and a database for storage of user data (including, but not limited to, user profile data, health data, behavioral data, fitness data and goal data). The AI agent and/or databases may be hosted remotely on one or more servers, or a portion or entirety of the functionality may be provided locally on the device; note that this implementation (providing on-device AI capabilities) enhances user privacy, data security and reliability.

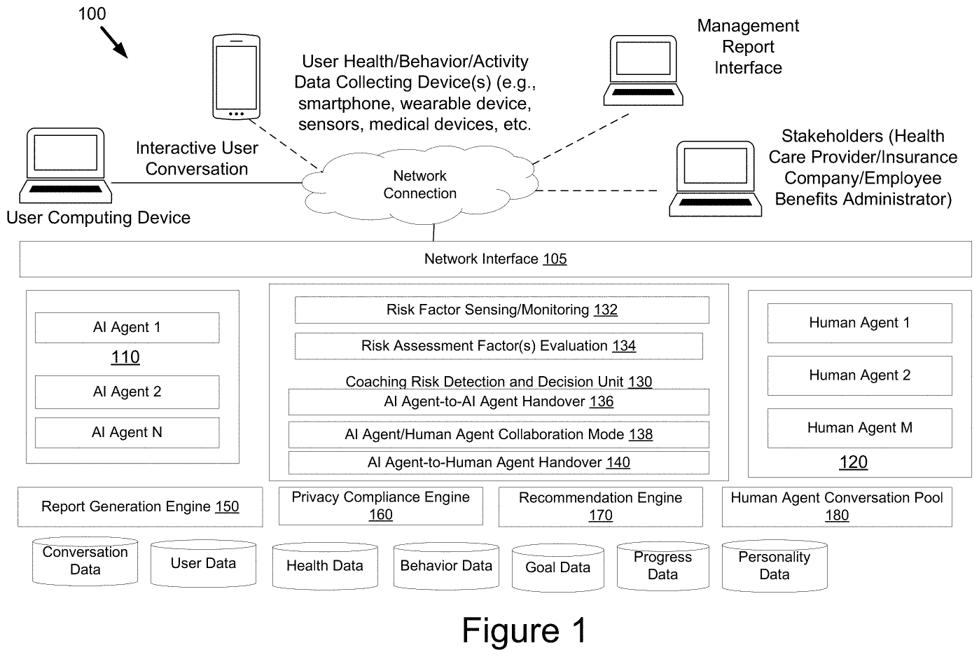

Referring to FIG. 1, a hybrid platform 100 has a communication interface 105 to interact with external computing devices. For example, a user computing device may be any device that allows a user to conduct two-way conversations with one or more of text, voice, emoji, image, animation, or video messages including, but not limited to, a robot, a chatbot, a smartphone, a laptop, a tablet, or a speaker. The user device is able to identify a user by user credentials including, but not limited to, account and password, voice match, face recognition or fingerprint.

The hybrid platform 100 includes AI agents 110 trained to engage in behavioral modification coaching sessions with users. There is at least one AI Agent type (e.g., different AI agent types 1 to N, where each AI agent type may have multiple instantiations. For example, while a single agent could handle multiple types of coaching, individual AI agent types may be trained to perform specific types of behavioral coaching or otherwise have different types of capabilities.

There is at least one human agent 120, although more generally there may be a total of M different human agents available at a given instance of time. The human agents may have similar training. However, more generally individual human agents may have different types of training and/or different levels of training and experience. For example, for a particular coaching goal, such as behavioral coaching for a health condition, such as diabetes, there may be a set of human agents that meet some minimal coaching standard. There may also be a group of human agents that are at some higher level of coaching standard due to additional training, experience, or aptitude.

An AI agent 110 may be trained to provide behavioral coaching sessions that include interactive conversations with users. The quality of behavioral coaching provided by an AI agent is likely to improve over time as more training data becomes available to address a wider variety of situations. However, even with extensive training, an AI agent may still not provide a satisfactory coaching experience for all possible users.

The hybrid platform uses a combination of AI agents and human agents. The AI agents may be used as a primary source for servicing coaching sessions with the human agents drawn into coaching sessions when there is a risk that an individual user is not receiving coaching that satisfies a desired level of quality in terms of user experience, advancement towards short-term goals, and advancement towards long-term goals. The decision to draw in human agents can be made when there is a clear problem in the quality of the coaching services provided by the AI agents. However, human agents can also be drawn in proactively before serious problems in the quality of the coaching arises.

There are different equivalent ways to articulate the hybrid mode of operation. Conversations may be transferred or also shared by agents when it increases the likelihood of a more effective conversation that helps a user to achieve their goal with some consideration of achieving consistent quality of coaching. However, this can also be articulated as identifying a risk of failure. In a platform with different types of AI agents, there may be automatic transfer between different types of AI agents when a second agent has a higher score for the likelihood of having a more effective conversation and helping a user to achieve their goal(s) in comparison with a first agent. We can also express this as transferring between different types of AI agents when there is a risk a conversation will fail to help a user achieve their goal(s) with the first agent with some level of coaching quality. Similarly, a transfer from an AI agent to a human agent may be initiated when a human agent is more likely to aid a user to achieve their goal in comparison to an AI agent. However, this can also be expressed as transferring to a human agent when there is risk the AI agent will fail to help a user achieve their goal(s) within some level of coaching quality. For example, an AI agent and a human agent may be nearly equivalent for servicing coaching conversations for a majority of cases. However, a human agent may provide superior coaching conversations for some users and some situations. This may occur for a variety of reasons, including limitations on the training data available to train an AI agent or other limitations within AI technology.

A coaching risk detection and decision unit 130 monitors risk factors, evaluates the risk factors, and makes decisions on when and how to draw in human agents. Some examples of decisions include a handover of a conversation from an AI agent to a human agent. In some implementations, the agent transfer unit may also implement a mode of operation in which an AI agent and a human agent work collaboratively to coach a user. In some cases, the decision may alternately include a handover of a conversation from a current AI agent to a different AI agent.

As an example, the coaching risk detection and decision unit 130 may include a risk factor sensing/monitoring unit 132, a risk assessment factor evaluation unit 134, an AI-Agent to AI agent handover unit 136, an AI Agent/Human Agent collaboration unit 136, and an AI agent to human agent handover unit 140. The individual units may be implemented in different ways, such as hardware, firmware, rule-based approaches, and machine learning (ML) methodologies.

In some implementations, interfaces are provided for interactions of the platform with stakeholders such as health care providers, insurance companies, or employer benefits administrators. For example, some employee benefit plans and insurance companies reimburse behavioral based therapy to prevent or mitigate health conditions. Such reports may also be automatically generated and securely transmitted to self-insured companies, employers, family members or other stake holders. The user's satisfaction level of the conversation session may also be collected and analyzed in the report. The correlations of the user's satisfaction level and human agents' involvement may be further analyzed and displayed in such reports.

A management report interface may be provided to interface with platform 100. For example, the operation of a platform 100 may monitor the performance of the platform 100.

In some implementations, the platform 100 includes a report generation engine 150. A privacy compliance engine 160 may be provided to deal with privacy concerns associated with maintaining and/or sharing health-related data. For example, the privacy compliance engine may address US government HIPAA requirements of privacy for health, insurance, and medical data. A recommendation engine 170 may be provided to aid human agents. A human agent conversation pool 180 may be included. For example, an AI agent to human agent handover may include scheduling the handover in regards to a pool of conversations queued up for one or more human agents.

A variety of different databases may be supported to aid platform 100. For example a conversation database, a user database, a health database, a behavior database, a goal database, a progress database, and a personality database may be maintained. Other databases may also optionally be supported.

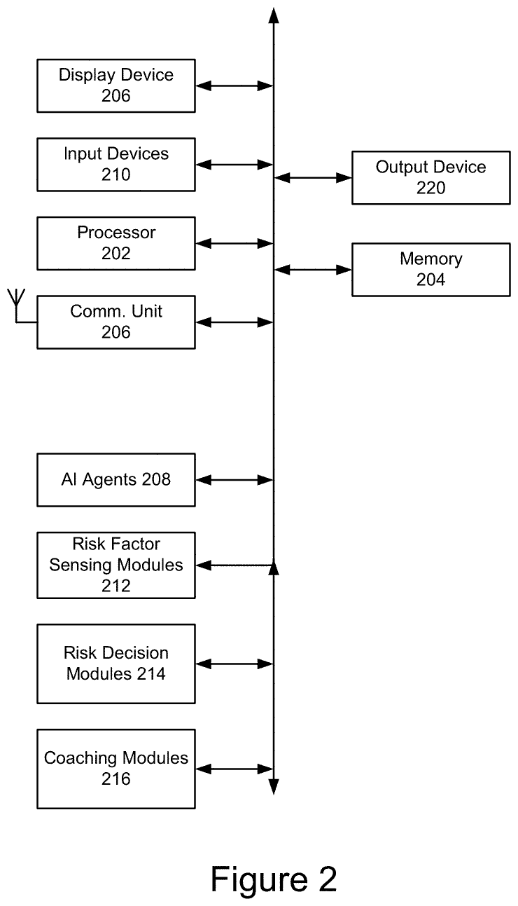

The platform may be implemented in different ways. For example, the platform 100 may be implemented on a network server as illustrated in FIG. 2 with a display device 206, input device 210, processor 202, network communication unit 206, output device 220, memory 204, and computer program code stored on a non-transitory computer readable medium to implement features such as AI agents 208, risk factor sensing module 212, risk decision modules 214, and coaching modules 216. An internal communications bus or network may support communication of the module in FIG. 2. Other examples of implementation include a cloud based implementation and a distribution computing implementation.

Individual application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language.

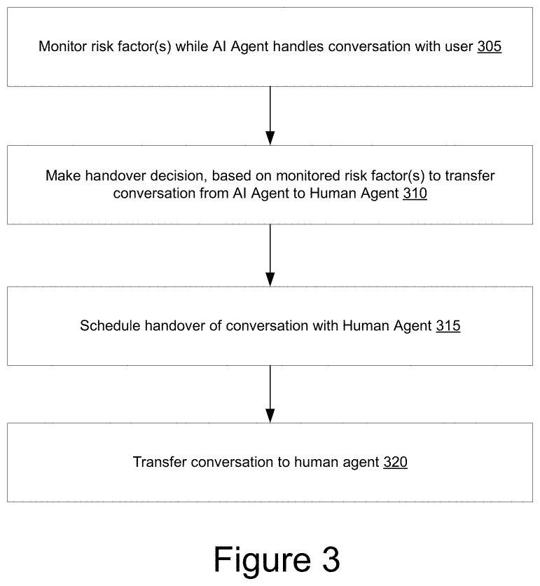

FIG. 3 is a flowchart of a method in accordance with an embodiment. In block 305, one or more risk factors are monitored while an AI agent handles a conversation with a user. As previously discussed, the risk factors may include a variety of risk factors relevant to a behavioral coaching conversation. In block 310, a handover decision is made, based on the monitored risk factors, to transfer the conversation from the AI agent to a human agent. In block 315, a handover is scheduled of the conversation to a human agent. For example, a particular human agent may have a queue of conversations, such as a current conversation, a next conversation, and so on such that there may be an expected wait time before a conversation can be transferred from the AI agent to the human agent. In block 320, the conversation is transferred to the human agent.

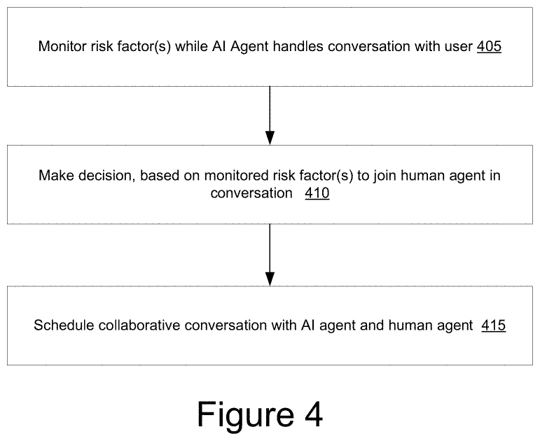

FIG. 4 is a flowchart of a method of collaborative coaching in accordance with an embodiment. In block 405, risk factors are monitored while an AI agent handles a conversation with a user. In block 410, a decision is based on the monitored risk factors to join a human agent in the conversation. In block 415, a collaborative conversation is scheduled in which a human agent joins in the conversation.

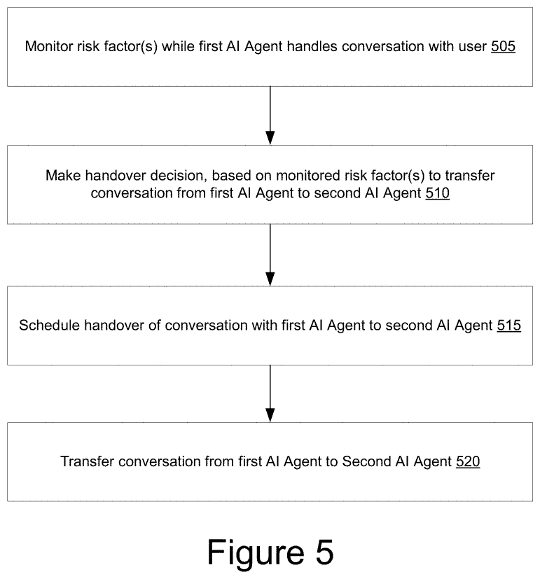

FIG. 5 is a flowchart of a method transferring a conversation in accordance with an embodiment. In block 505, risk factors are monitored while a first AI agent handles a conversation with a user. In block 510, a handover decision is made based on the monitored risk factors to transfer the conversation from the first AI agent to a second AI agent. In block 515, the handover of the conversation is scheduled from the first AI agent to a second AI agent. In block 520, the conversation is transferred from the first AI agent to the second AI agent. As an illustrative example, the second agent may be a different type of AI agent with a different skill set than the first AI agent.

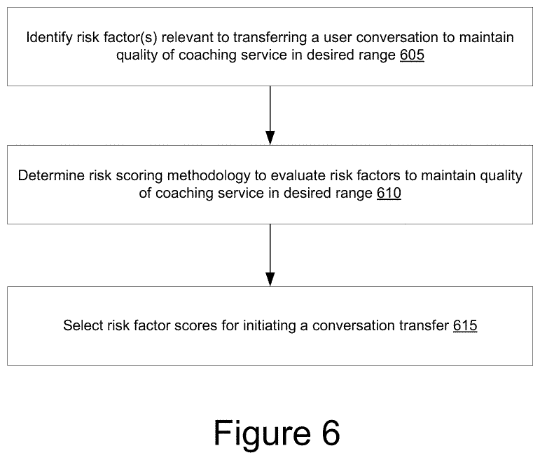

FIG. 6 is a flowchart of a method of selecting risk factors in accordance with an embodiment. In block 605, risk factors are identified that are relevant to transfer a user conversation to maintain a quality of a behavioral coaching service in a desired quality range. In block 610, a risk factor methodology is determined to evaluate the risk factors to maintain a quality of a coaching service in a desired range. In block 615, risk factor scores are selected for initiating a conversation transfer. One aspect illustrated in FIG. 6 is that different tiers of service may be supported. In some embodiments, at least two tiers of service will be offered to users. Tiers of service may differ in prices and/or categories, and thus the service may have different levels of involvement and expertise of human coaches. For example, a lower cost tier of service may limit the total amount of time from human coaches and/or the frequency of human coaches' engagement with the user. A senior human coach with more experience and past user satisfactions may be selected to engage with a user from a premium service plan. Additionally, the tier of service may also have different ranges of services in terms of range of expertise. In addition to the cost difference, the service may be categorized according to different coaching goals such as weight loss, diabetes prevention, chronic disease control and management, and more. In these cases, the selection of human coaches will also consider their expertise fields and select the one who has experience and knowledge in this specific coaching area.

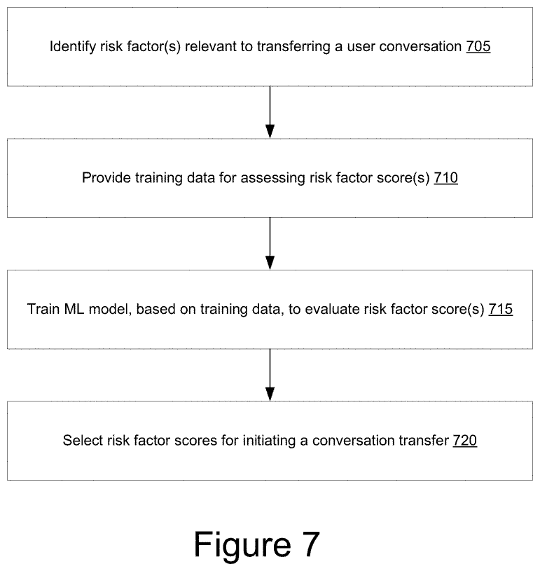

The evaluation of risk factor scores for making decisions may be determined in different ways, such as a rule set or based on a machine learning model. FIG. 7 is a flowchart illustrating a method of training a machine learning module to evaluate risk factors. In block 705, risk factors are identified for transferring a user conversation. In block 710, training data is provided for assessing risk factor score(s). In block 715, a machine learning model is trained, based on the training data, to evaluate risk factor score(s). The machine learning model may be used to select risk factor scores for making a decision, such as initiating a conversation transfer in block 720.

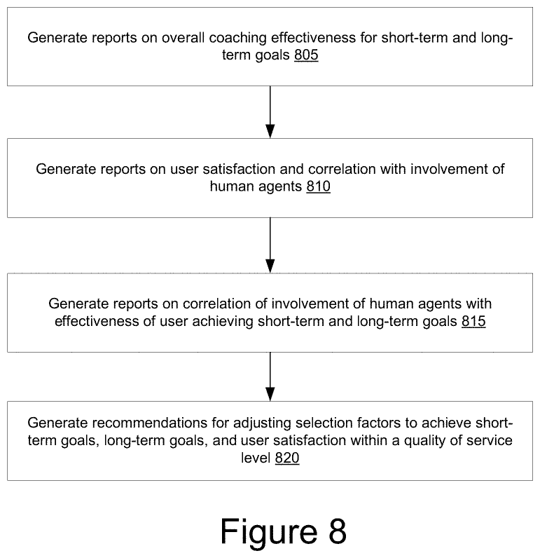

FIG. 8 is a flowchart illustrating an example of report generation. In block 805, reports are generated on overall coaching effectiveness for short-term and long term goals. In block 810, reports may be generated on user satisfaction and correlations with involvement of human agents. In block 815, reports may be generated on involvement of human agents with effectiveness of user achieving short-term goals and long-term goals. In block 820, recommendations may be generated for adjusting selection factors to achieve short-term goals, long-term goals, and user satisfaction within a quality of service level.

One aspect of report generation is that in a scalable coaching platform a challenge is to leverage the use of AI agents for scalability and to use human agents as required to maintain consistent high quality service with some standard of quality. For example, a certain percentage of users may require more human coaching than others. Also, some phases of coaching may benefit more from human coaching than others. Reports may be generated for a platform manager and for one or more stakeholders to understand tradeoffs. For example, an employee benefits administrator or an insurance company may be interested in some of the different tradeoffs possible by making different types of decisions to draw in human agents.

### ADDITIONAL EXAMPLES

In some embodiments, the user's emotions and personality are analyzed from the current conversation messages, along with messages from previous conversations and contexts from the current as well as previous conversation sessions. In some embodiments, this may be accomplished by a combination of Natural Language Processing (NLP), Natural Language Understanding (NLU) processing and/or sentiment analysis. Other information in conversations may be analyzed, including answers to questions asked of the user, user diaries, and other data directly or indirectly provided by the user. A user device could be used to provide data indicative of a user's behavior or a user could be queried to provide the data. For example, smartphone location data could be used to assess a frequency a user visits a local gym, a user could input data on gym attendance, or sensor data (e.g., a user's heart rate monitor) could be used to assess user exercise patterns.

Consider now an example of a collaboration mode. In some embodiments, instead of switching the conversation mode between an AI agent and a human agent, AI agents and human agents can work together in a collaborative mode. In this mode, the AI agents will generate one or more action recommendations for the human agents based on the current conversational context, the user's conversation and behavior change history. The action indicates what the AI agents will do or say. Under one action, there may be multiple messages with different coaching styles. If more than one action or messages are recommended by the AI agents, a ranking mechanism may be used to rank these actions and messages. For example, the ranking mechanism may calculate the relevance between the action and the conversational context, and the predicted user's preference levels for each message based on historical conversation data and user's personalities. The user's behavior change statistics may also be provided to the human agents. The human agents can select a message from an action recommended by the AI agents or update the message in the action and then send to the user. If there is no appropriate action recommended by the AI agents, the human agents can also add an action with a responding message associated with this action. If the human coaches update an action or a message, the updated information will be saved to a database that trains the AI agents. The training process may be triggered automatically or manually.

The individual AI agents 110 may be implemented as intelligent chatbots that are trained to communicate with users and help provide behavioral coaching to users to meet their short-term and long-term goals. However, an individual AI agent may not always meet the expectations of a user in terms of providing an expected level of quality in terms of the user's experience and advice for meeting short-term or long term goals.

Long-term goals are personal goals that a user wants to achieve over a period of time. In some cases, these long-term goals may be achieved progressively through a series or sequence of shorter-term goals or steps that may be monitored for completion. In some cases, a long-term goal may be broken into multiple shorter-term goals using a rule or decision process that determines milestones or other intermediary goals. Conversations (particularly a single conversation) typically involve a more immediate goal, such as helping a user accomplish a specific task such as tracking and recording food consumption, exercise and sleep, getting advice, finding a recipe, etc. In contrast, long-term goals are beyond the scope of single conversations and are gradually achieved by obtaining coaching. Some long-term goal examples include, but are not limited to, weight loss goals, blood glucose level goals, health and fitness goals, behavior change goals and medicine adherence goals.

Returning to the platform 100, in some embodiments, a user may also provide behavioral data to the platform 100. For example, a user may keep a behavioral diary that is loaded or maintained in the platform 100, such as a diet, exercise, sleep patterns or other type of diary. The user could also be queried in a conversation to obtain behavioral data. Moreover, in some implementations, other types of data may be collected. For example, some types of medical devices, health devices, sensors, wearable devices, and smartphones permit the collection of data such as exercise patterns, sleep patterns, weight, biometric data on health, etc. Some smartphones and smartwatches include sensors that can measure position, acceleration, and other parameters from which exercise patterns can be estimated. Some smartphones permit pictures and/or descriptions of foods or recipes to be entered and nutritional information to be determined.

In some embodiments, the decision process to make a decision to draw in a human agent to a coaching conversation involves evaluating the risk levels a conversation will fail, where failure may be in the context of perceived and actual coaching quality. For example, if the user is subjectively satisfied or dissatisfied is a factor in providing a quality of service. However, whether an AI agent is providing useful advice for a user to achieve short-term or long-term goals is another factor. For example, a user may not be progressing towards a short-term goal that is a milestone. As one example, for weight loss a user may hit a weight plateau, which if it continued might constitute a failure in the sense the user was not advancing towards a short term weight loss goal. An AI agent may also lack training to address a particular problem of a user, and thus be a failure in regards to proving advice in a conversation session. For example, an AI agent may not be trained to provide advice for unusual situations, such as a user on vacation trying to maintain a diet.

In some embodiments, a risk a conversation will fail is evaluated by looking at the user's satisfaction/dissatisfaction levels with the conversation, the user's request, and/or the inability of the AI agents to handle the particular conversation. The current conversation session may be considered independently (or combined with, or considered with, the user's previous conversation history) to calculate a normalized score between 0-1, with a higher score indicating a higher level of risk that the conversation will not be successful in addressing the user's needs. The risk to the user's achievement of long-term goals are evaluated by the current status of and progress towards these goals, which may be broken down into shorter-term goals and tasks to calculate a normalized score between 0-1, with a higher score indicating a higher risk to achievement of the user's goal or goals.

In some embodiments, other factors may also be evaluated and included in the risk assessment or decision process, including but not limited to the topic(s) of the conversation and its relevance to the long-term goal(s), short-term goals and tasks, the workload of the human agent platform, and the number of users in an active conversation.

The conversation risk score, the long-term goal achievement risk score and/or the additional factors may be combined to generate a normalized final score between 0-1. The combination may be performed by using a weighted sum, with the weights optimized from the user's previous data and/or other users' data.

In some embodiments, a weight optimization process may use a machine learning model to determine the weights for each user that maximize the likelihood of completing the conversation, achieving short-term goals/tasks, and/or long-term goals.

Switching or transferring from an AI agent to human agent(s) may be triggered or initiated if the final score exceeds a certain level or threshold. Note that the conversation risk score may change at each turn of the conversation due to changes in user input messages, but the risk assessment will generally take into account the previous messages and risk status. The long-term goal achievement score also changes to reflect the most recent status or progress towards achieving a goal or goals. In addition to changes based on user behavior or messages, the threshold level of the combined score for a transfer decision may also change due to changes in the workload of the human agent platform as well as the risk status of other users at that time.

In addition, the decision process can learn from a user's past transfer conditions and performances thereafter, such as frequencies of conversation, achievements of shorter-term goals and tasks. It can also learn from other users to adopt a best decision rule for the user by maximizing the likelihood of achieving the shorter-term goals/tasks as well as the long-term goal(s).

Note that a user's behavior data from the user's previous or concurrent conversations, as well as other resources, may be used for the purpose of assisting a behavior change for the user, and (or instead) may be used for other applications that may be or may not be directly related to behavior changes. For example, the user's diet data may be used by a recommendation engine to recommend a relevant restaurant or a healthier, alternative food. The exercise data may be used to personalize an exercise prescription or recommend a workout exercise or class. The user's schedule data may be used to remind the user of certain tasks or notify the user of specific information at the right (optimal) moment. The use of behavior data in the situations described above or in other applicable situations may be conducted by the AI agents or human agents in the platform described herein. It may also be used outside of the platform in another application.

Note that protected health information (PHI) may be automatically detected and removed or hidden in trainings of AI agents and machine learning algorithms in order to comply with Health Insurance Portability and Accountability Act (HIPAA).

The conversation data between the user and an AI agent and/or human agent(s), as well as the user's behavior change data may be collected and analyzed to generate one or more reports by the system. These reports may show data including, but not limited to, the trend of the user's behavior change, the efficacy of coaching on the user's behavior change and the correlations between the conversation data and the user's behavior change data. These reports may also be sent automatically, securely and electronically to one or more healthcare providers and/or health insurance plans.

In some embodiments, the user's level of satisfaction or dissatisfaction may be determined by detection of emotion related words, phrases, voice tones, emojis, or pictures. The conversation risk may be determined as a level of satisfaction/dissatisfaction as indicated by the current user's message. It may also be determined by calculating the weighted sum of the levels of satisfaction/dissatisfaction for one or more previous messages in a conversation session. In addition, the ability or inability level of the AI agents may be determined by unidentified intentions that represent the purpose or goal of a user's input, intentions with low confidence scores, a user's specific request for human intervention or patterns of user input messages, such as repetition of the same intention or goal.

The conversation risk level may be independently determined by the user's level of satisfaction/dissatisfaction or the ability or inability level of the AI agents, or by combining both together as a weighted sum. Alternatively, in some embodiments, the user's conversation risk may be determined by a machine learning model. In this example, the user's conversation history is fed into a Feature Extraction Module where the features such as meanings, entities, intents, sentiments are extracted. These features are processed in a Score Calculation Module where previously trained machine learning models such as neural networks, SVMs, logistic regressions etc. are used to calculate at least one score. The scores may then be normalized in a Score Normalization Module based on machine learning models and/or rules to generate a normalized score between 0-1. In some embodiments, the AI agent service also analyzes user data related to the achievement of long-term goals, such as the user's health data, fitness data, behavior data, goal progress data, profile data, emotion data and personality in order to evaluate the risk to the user achieving their goals, and in response generates at least one goal-related risk score.

The long-term goals may include health related goals and/or behavior change goals that can be further broken down to shorter-term goals and tasks. The status of and progress towards the achievement of these shorter-term goals and tasks, the time and order of those already accomplished, and in-progress and to-do goals and tasks, are monitored and tracked by the AI agents as goal progress data. In some embodiments, the shorter-term goals leading to a long-term goal may cover different behavior categories, such as eating behaviors, exercise behaviors, sleep behaviors, etc. The risk score for each behavior category may be calculated and the risk score of the long-term goal may be then determined by combining the risk scores for each category with a respective weighting. In some embodiments, a Feature Extraction Module may be used to extract the features from the user's goal and task achievement history, the to-do-list of goals and tasks, the goal progress data and other user-related data, such as personality, emotional and stress status that may affect the user's behaviors. The features are then input to a Score Calculation Module where previously trained machine learning models such as neural networks, SVMs, logistic regressions, etc. are used to predict the likelihood of achieving one or more long-term goals. The risk score(s) for the long-term goal(s) are generated after normalization in a Score Normalization Module by machine learning model and/or rules.

A variety of factors, including the conversation risk score, the conversation topic(s), the risk to achievement of the user's goal(s), and the workload of the human agent the user is assigned to (and that of the entire human agent platform) are then evaluated by specific algorithms, machine learning models and/or statistical models to decide whether (and when) a conversation needs to be transferred to human agent(s) on the human agent platform.

In addition to the conversation risk and the risk to achievement of the user's goal(s) that have been discussed above, the relevance of the conversation content with respect to each shorter-term goal and task may be analyzed by comparing the labelled tags of these goals/tasks with the meanings, intents and keywords extracted from the conversation messages. If the current conversation content is related to the topic(s) of one or more goals/tasks, then the risk levels to achievement of these goals/tasks may also be used in addition to that of the risk to the long-term goal. The workload of the human platform is analyzed to generate an estimated wait time or a range of wait time for the user being transferred. The wait time may be estimated by the workload of the human agent the user is assigned to or that of another human agent who has least workload at that time.

In some embodiments, the user's conversation risk score, the goal achievement risk score(s) and the relevance index multiplied by the importance factor of the short-term goal/risk are summed by their weights to generate a final risk score. The user is ranked from most at risk to least at risk among all the active users by the final risk score. The active users are the users who are currently in an active conversation session with an AI agent or human agent(s). The estimated wait time may then be used to calculate a number for the users who can potentially be transferred and thus generate a cutoff number. Based on the risk ranking, the users above the cutoff number may be transferred to the human agent.

Alternatively, in some embodiments, the conversation risk score, goal achievement risk score(s), the conversation topic(s), the shorter-term goals/tasks in progress, the workload of the human agent platform and other necessary data may be input to a Score Calculation Module wherein previously trained machine learning models such as neural networks, SVMs, logistic regressions, etc. are used to generate at least one score. The score(s) is then normalized in a Score Normalization Module with machine learning models and/or rules to generate a normalized score between 0-1.

Note that the rule-based methods and processes described herein may be combined with machine learning models to optimize the algorithms, decision methods and processes for each user. For example, the weights of factors may be determined by the machine learning models as a result of being trained using the user's previous data or other user's data. The user's previous data, the entire user population's data or data from a set of users with similar backgrounds may be used by the machine learning models.

The AI agent service may have more than one AI agent. Different AI agents have different conversation goals, content and style, and personality. For example, an AI agent may be a task-oriented AI agent for conducting conversations with a user for specific tasks such as food coaching, exercise coaching, sleep coaching, stress coaching, blood glucose management and blood pressure management. An AI agent may also be a non-task-oriented AI agent such as a chit-chat agent. The AI agent service has at least one task-oriented AI agent. In addition to the task-oriented AI agents, and depending on different service offerings, the AI agent service may have at least one non-task-oriented AI agent or may not have a non-task-oriented AI agent. The AI agent service analyzes the user's status including, but not limited to, conversation messages, user's health and fitness data and behavior data, user's emotion data and personality type to select the AI agent that maximizes the likelihood of achieving the user's conversation goals as well as long-term personal goals.

Note that in some embodiments, the AI agent may not function as a question-answer or command-like agent that only supports one response or one conversation goal (although in some cases it may be designed to operate in that mode). The conversations between a user and an AI agent are typically multi-turn conversations and may cover more than one topic. The AI agent selects a topic to start a conversation or is directed to a topic within a conversation that is already started by a user. The topic selection method evaluates the current conversation, previous conversations, and the user's data including, but not limited, to health data, fitness data and behavioral data, to pick the topic that maximizes the likelihood of achieving the user's goals by using behavior models, machine learning models, statistical models, and/or other relevant models.

In some implementations, the transfer from an AI agent to another AI agent may be triggered or initiated when the current conversation between the AI agent and a user meets a specified condition, such as:

1) the tasks of the current AI agent are accomplished; or

2) the conversation is at risk;

3) the user is dissatisfied; or

4) the user specifically requests a specific AI agent.

The AI agent that is selected for a user is selected based on the method that maximizes the likelihood of achieving the conversation goals and the user's long-term personal goals.

The human agent platform has at least one human agent. When the conversation is transferred from the AI agent service to the human agent platform, the conversation content as well as the user's summary (and/or metadata) that may help the human agent to make the conversation more effective. Such information may include, but is not limited to, health data, fitness data, behavior data, emotion(al) status, personality and progress toward goal achievement, some or all of which may be displayed to the human agent who is concurrently or previously assigned to the user. If the user does not have an assigned human agent, or the assigned human agent currently has too great a workload, then the conversation may be handed over to a human agent(s) who has the least workload and is familiar with the topic of conversation.

If more than one user needs the human agent's intervention, then the users will be placed into a pool with a ranking method. The ranking method may evaluate the overall risk score of the user, the conversation time and the number of users in the pool to determine the position in the pool where the user should be ranked or placed. In addition, a color tag indicating the overall risk score may be displayed to the human agent along with the user's other information.

In one embodiment, the human agent is able to select the user from the pool to engage in the conversation. When the conversation between the user and the human agent is completed, the human agent may hand the conversation back to the AI agent service in one of several modes, such as continuing the conversation, ending the conversation, or starting a new conversation topic (which may be decided and selected by the AI agent service or by the human agent).

In some embodiments, a list of conversation topics may be generated by a recommendation engine that selects the most relevant topics related to the current conversation between the user and the human agent, with the list of conversation topics being maintained, updated and displayed to the human agent in the course of a conversation.

User data including, but not limited to, user profile data, health data, fitness data, behavior data, goal progress data, and personality type data is collected by extracting information from the user's conversations in a conversational user interface, from user entries in a graphical user interface, and/or from wearables, smartphones, medical devices or other digital devices. The collected data is stored in databases and used for analysis by the AI agent service and the human agent platform. User profile data such as age, gender, ethnicity, hobbies, preferences, etc. may be entered by the user or extracted from a conversation. It may also be analyzed by using the user's past behavior data such as activities and foods to generate data for the user's profile.

In some embodiments, this analysis may be conducted by matching the tags extracted from the user's past behavior data to the tags based on what is learned from other users. The user's profile may be used to help the AI agents provide the appropriate coaching and suggestions to match the user's preferences. Health and fitness data such as weight, BMI, body fat, blood glucose, blood pressure, blood lipids, sleep quality, stress levels, etc. may be used to develop the goals the user wants to achieve over a period of time. One or more types of health and fitness data may be used to generate or form one or more long-term goals for the user. The monitoring of the health and fitness related data reveals the overall status and changes in the progress towards achieving the long-term goals. For example, a diabetes coaching agent may monitor and use the user's weight, BMI, blood glucose, and diet data to generate one or more personalized goals such as weight loss target, the percentage of healthy food in diet, and fasting and after-meal glucose levels. These goals then can be tracked to determine the user's status and progress.

Alternatively, the long-germ goal(s) may be developed by using the user's behavior data independently or in combination with the user's health and fitness data. Behavior data comprises the user's behavior patterns, such as sleep patterns, activities patterns, diet patterns, work schedules and meal schedules, etc. These patterns reflect the user's behaviors that may affect achievement of the long-term goals. Risky behavior patterns for achieving certain goals are detected by comparing the user's behavior patterns with those who have achieved their goals or failed to achieve their goals. Changes in these risky behavior patterns may be accomplished by shorter-term goals and tasks presented in action plans. The long-term goals and the shorter-term goals and tasks are tracked, and their status and progress information are monitored and saved, as indications of progress or a lack of progress to determine the risk to achievement of the long-term goal(s).

In some embodiments, the “conversation risk” is determined based on one or more of conversation status, the emotion(al) status of the user, and the personality aspects of the user. The “goal achievement risk” is determined based on one or more of user profile data, user behavior data, and user goal data.

The data used in assessing both types of risk may be obtained from multiple sources, including, but not limited to, conversation history, user provided data, user health, fitness and behavior data obtained from a wearable or user data entry, sensor data, health records, etc. The conversation risk considers the user's satisfaction or dissatisfaction levels with a conversation and the ability or inability of an AI agent to assist the user. User status, such as emotion(al) status and/or personality, which are expected to have an effect on the success of the conversation may also be used to determine the conversation risk. The goal achievement risk may be determined by the user status with regards to (and progress towards the achievement of) short-term goals and tasks that lead to successful achievement of a long-term goal. A long-term goal such as a health goal or behavior change goal can usually be broken down into a series of shorter-term goals and tasks. These shorter-term goals and tasks may be personalized for each user with regards to order and amount of time for completion to have a higher likelihood of the user achieving the long-term goal.

The personalization may be achieved by learning from the user's past experience and other users' experiences. The shorter-term goals/tasks may include the ones that have been accomplished, failed, in-progress or in the to-do list. The time a user spent achieving each goal/task and/or the order of the task achievement may also be included in the decision process for the goal achievement risk(s). The conversation risk score and the goal risk score(s) may be combined with other related information and then used to calculate or generate an overall risk score that is compared with a threshold value. The threshold may be affected by the workload of the human agent platform as well as the number of active users during a conversation session. If the overall risk score is above the threshold, then the user is asked to transfer to human agent(s). Once the human agent finishes the necessary conversation with a user, the conversation may be handed back to one of the AI agents to end, continue the current conversation or start a new conversation topic.

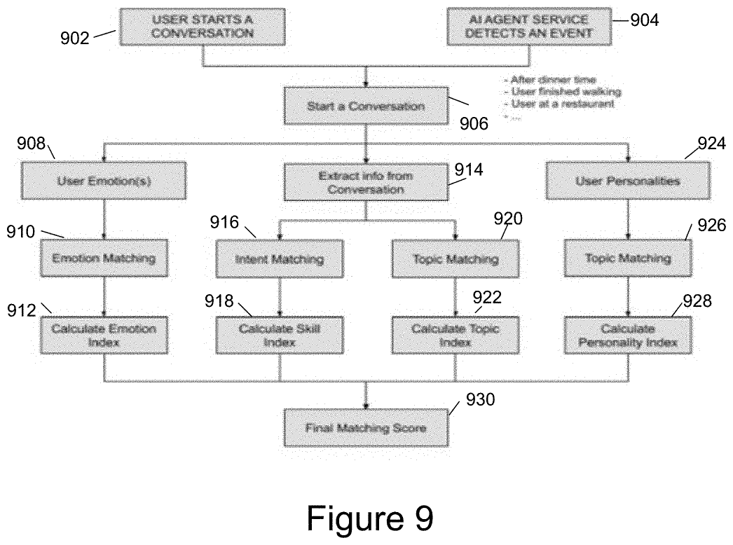

FIG. 9 shows a method and process of determining how to match a user with an AI agent by determining a matching score between a user and an agent with respect to a conversation. The start of a conversation 906 may be triggered by the user initiating a conversation 902 or by an event detected by the AI agents 904. If a specific event is detected, then an AI agent may start a conversation related to that event (e.g., an AI agent with access to a user's smartphone data may detect the local time of day for the user, whether the user finished a walk, etc.).

The conversation meanings are extracted to get the intents, entities, sentiments and topics, typically by using natural language processing methods and/or sentiment analysis. The user's emotion(al) status 908 is determined from matching the emotions 910 to the conversation sentiments and/or from other sources such as voice tones, facial expressions, behavior patterns, etc. The user's historical emotion(al) levels may also be included for calculating an emotion index 912 of the current level. A user's personality determination 924 may include performing topic matching 926 to calculate a personality index 928. Other information may be extracted 914 from the conversation. Intent matching 916 may be used to aid in calculating a skill index 918. Topic matching 920 may be used to calculate a topic index. As indicated in FIG. 9, a variety of types of information may be used to generate a final matching score. For example, suppose a conversation is started related to the topic of a weight loss diet. The emotion of the user may be determined such as whether the user is angry, sad, bored, or depressed. The user's intent (e.g., trying to get nutrition coaching on food) may be considered as well as the topic of the conversation (e.g., low glycemic index foods). The user's personality may also be considered (e.g., thinking type versus feeling type).

The AI agents may include AI agent types for different types of users. This permits selecting an agent for a user based on the conversation history and behavior history to an AI agent that has a matching personality. Note that the AI agents may differ from each other by the tasks and/or topics they are familiar with. They may also be designed for catering to user's different emotion(al) status and personalities.

Information and data including the conversation information, the user's emotion(al) status and user personality may be used independently or combined as part of the AI agent selection process. In some embodiments, the confidence scores of the user's intentions, purpose or goals may be used to rank the AI agents with regards to their task handling capability in order to generate a skill index for each AI agent. It may use one or more confidence scores of the intentions from each agent to generate the skill index. The conversation topic information may be used to generate a topic index for the AI agents (chitchat only or both task oriented and chitchat) by tag matching or other methods, with a higher index indicating a higher topic relevance. The emotion(al) and personality matching between the user and the AI agents may be processed by a tag matching method to generate an emotion index and a personality index for each AI agent. The skill index, topic index, emotion index, and personality index may then be used independently or combined by their weights to generate a final matching score for each AI agent. The AI agent with the highest matching score may be selected for the conversation with the user. The selection of an AI agent and/or switching between AI agents may be processed and conducted during a conversation, at the beginning of a conversation or based on the occurrence of one or more specific conditions during a conversation.

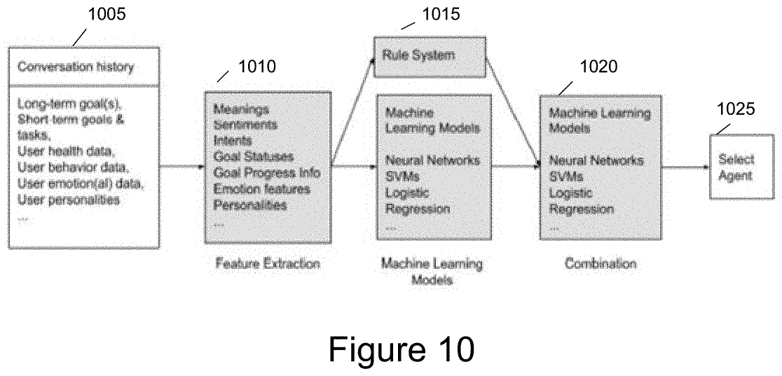

In some embodiments, the decision method and process for selecting an AI agent may be performed by a machine learning approach, as shown in FIG. 10. In this embodiment, conversation history data, goal-related data and user-related data are used as input data 1005 and provided to a Feature Extraction Module 1010 where features such as the meanings, sentiments, intents, goal status and progress, emotion(al) status and personality is extracted or derived from the input data. These features may then be further processed by one or more machine learning models 1005 such as Neural Networks, SVMs, logistic regression, etc. and/or by a rule system. In the Combination Module 1020, the data from machine learning models and/or rule system(s) may be combined to generate one or more scores to select an AI agent 1025.

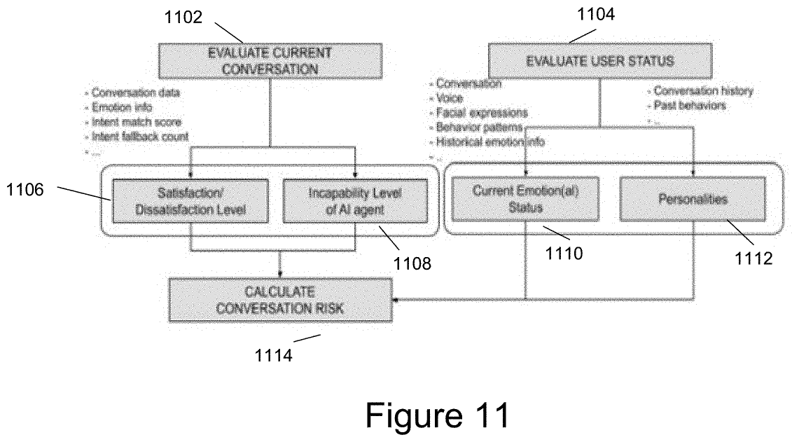

FIG. 11 shows an example of a decision process for calculating a conversation risk. The current conversation is evaluated 1102. The user's level of satisfaction or dissatisfaction 1106 may be determined by detection of emotion related words, phrases, voice tones, emojis, pictures, etc. In addition, or instead, a sentiment analysis model may be used. The ability or inability level of an AI agent may be determined 1108 by the detection of certain patterns in the conversation, including, but not limited to, a request for human intervention, unidentified intents, intents with low confidence scores, or repetition of the same intent.

The user status is also evaluated 1104. The user's emotion(al) status 1110 and personality 1112 may also be considered to help adjust the conversation risk 1114 as determined from the conversation itself. The user's emotion(al) status may be determined from the conversation, including the detection of emotion related info and/or by a sentiment analysis model; it may also be obtained from other resources such as voice tones, facial expressions, behavior patterns, etc. The history of the user's emotion(al) status may also be used to determine the user's current emotion(al) status. The user's personality is based on the personality traits detected from the user's history of conversations and behaviors. In some embodiments, the conversation risk may be determined by combining the user's satisfaction/dissatisfaction level and the ability of an AI agent as a weighted sum. In some embodiments, the conversation risk may be determined independently from the user's satisfaction/dissatisfaction level or the ability of an AI agent.

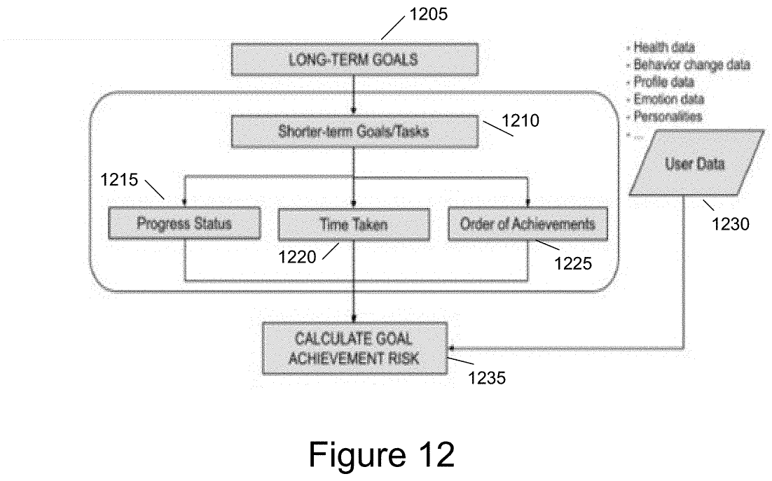

FIG. 12 shows an example of a decision process for calculating the risk(s) to achievement of the user's long-term goal(s) 1205. The long-term goals may include health related goals and/or behavior change goals that can be represented as a set of shorter-term goals and tasks 1210. The status of and progress 1215 towards the achievement of these shorter-term goals and tasks are monitored and tracked as goal progress data. In addition to the accomplishment status and progress status for these shorter-term goals/tasks, information including (but not limited to) the order of accomplishment of the goals/tasks 1225 and the amount of time 1220 the user spent on reaching each goal/task may also be included in the decision process. The user profile data and personality data may be used to decide the list of, the order of, and the time needed for accomplishing short-term goals and tasks that result in the highest likelihood for the user to achieve their long-term goal(s). The user profile data, along with emotion(al) and personality data 1230, may also be used to help predict the likelihood of a user achieving these shorter-term goals/tasks as well as their long-term goal(s) in block 1235.

The goal likelihood score(s) may be determined or calculated using a machine learning model based on data obtained from all or a set of users, such as users sharing similar characteristics (i.e., similar goals, personality, health and behavior status) with the user. The risk to achievement of the long-term goal(s) may then be calculated from the progress status of the relevant shorter-term goals/tasks, including those that have been accomplished, failed, in progress and in the to-do list. In some embodiments, the shorter-term goals leading to the achievement of a long-term goal may be part of different behavior categories, such as eating behaviors, exercise behaviors and/or sleep behaviors. The risk score for each behavior category may be calculated and the risk score for the long-term goal may be then determined by combining the risk scores for each category with their respective weights.

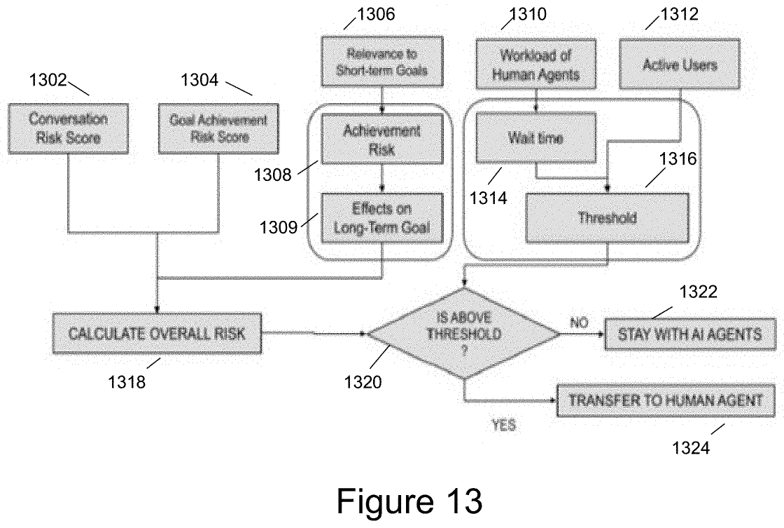

FIG. 13 shows an example of a decision process for calculating the overall risk based on the conversation risk 1302 and the goal achievement risk(s) 1304; it may also consider other factors, including but not limited to the relevance of the conversation content to the shorter-term goals/tasks 1306, the workload of the human agents 1310 and the number of users in an active conversation session. The relevance of the conversation content with respect to each shorter-term goal and task may be analyzed by comparing the labelled tags for these goals/tasks with the meanings, intents and keywords extracted from the conversation messages. If the current conversation content is related to the topic(s) of one or more goals/tasks, then the risk levels to achievement 1308 of these goals/tasks may also be used in addition to that for the long-term goal 1309. The related shorter-term goals/tasks may have different effects on the achievement of the long-term goal(s), and an importance factor for each goal/task may be generated for use as a weight.

In some embodiments, a threshold value 1316 may be determined by the workload of the human agent platform and the number of active users currently in a conversation session. The workload of the human platform is analyzed and evaluated to generate an estimated wait time 1314 or a range of wait time for a user. The wait time(s) may be estimated by the workload of the human agent the user is assigned to or other human agents who have the least workload at that time.

In some embodiments, the user's conversation risk score 1302, the goal achievement risk score 1304 and the relevance factor index 1306 from the importance factors for the short-term goal/risk may be summed by their weights to generate a final overall risk score 1318. The final risk score is then used to rank a user from most at risk to least amount of risk among the active users. The active users are the users who are currently in an active conversation session with an AI agent or human agent(s). The estimated wait time may be then used to calculate a number for the users who can potentially be transferred and to generate a cutoff number, which can be expressed in terms of a threshold condition 1320 Based on the risk ranking, the users above the cutoff number may be transferred to the human agent 1324. Users below the cutoff stay with an AI agent 1322.

As previously discussed, the conversation risk may be articulate in terms of a risk of failing to maintain the behavioral coaching within a desired range of quality in terms of different factors. Thus, in FIG. 13, different factors are considered together in combination to achieve the scalability afforded by AI agents with human agents drawn in to handle conversations when necessary to maintain the quality of the coaching experience for users.

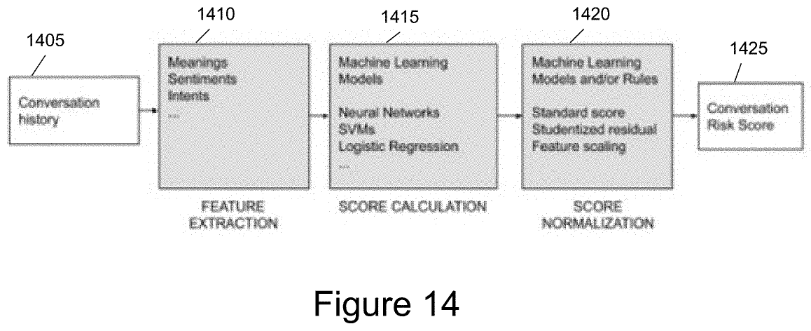

FIG. 14 is a diagram illustrating a determination of the conversation risk, the risk(s) to the achievement of long-term goal(s) and the overall risk by use of a machine learning model. FIG. 14 shows the process and method of calculating a conversation risk score based on the conversation history 1405. The conversation history data is provided to a Feature Extraction Module 1410 wherein the features, including, but not limited to, meanings, entities, intents, sentiments, and user emotions are extracted. These features are then processed in a Score Calculation Module 1415 wherein previously trained machine learning models such as neural networks, SVMs, logistic regressions, etc. are used to calculate at least one score. The score(s) are further normalized in a Score Normalization Module 1420 based on machine learning models and/or rules to generate a normalized score between 0-1 as the conversation risk score 1425.

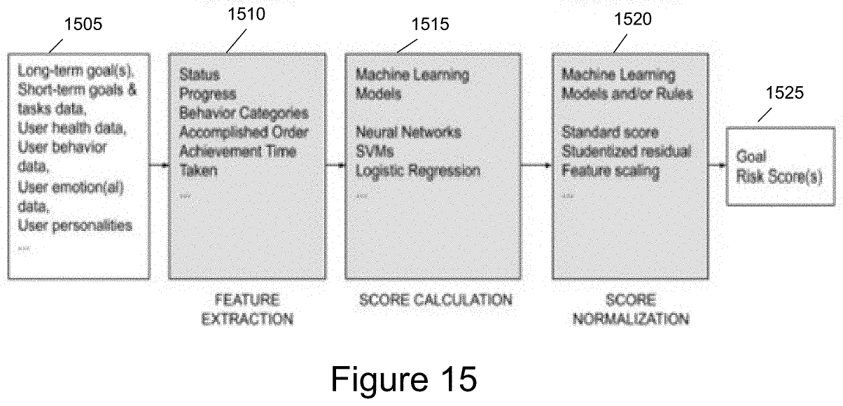

FIG. 15 shows a process and method of calculating at least one goal achievement risk score(s). User-related data 1505 is provided to a Feature Extraction Module 1510, wherein features are extracted from the user's goal and task achievement data (including the ones accomplished, failed, in-progress and in to-do list), the behavior change data, and other user data (such as personality, emotional and stress status) that may affect the user's behaviors. The features are then provided to a Score Calculation Module 1515 wherein previously trained machine learning models such as neuron networks, SVMs, logistic regressions etc. are used to predict the likelihood for achieving the long-term goal(s). The risk score(s) 1525 for the long-term goal(s) are generated after normalization in a Score Normalization Module 1520 by machine learning model and/or rules.

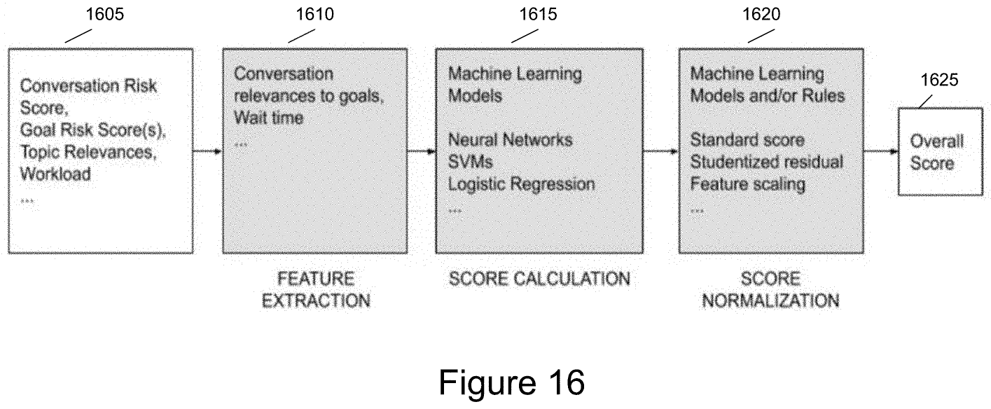

FIG. 16 shows a method and process for calculating the overall risk score 1625 by using input data 1605 that may include the conversation risk score, goal risk score(s), the relevance of the conversation content with respect to each shorter-term goal and task and the workload status of the human agents, etc. as input data. Features such as relevance index, wait time etc. are extracted from the input data by the Feature Extraction Module 1610 and then previously trained machine learning models are used in the Score Calculation Module 1615 to generate the score(s). The score(s) can be normalized in the Score Normalization Module 1620 by machine learning models and/or rules to generate a normalized overall risk score which can then be compared with a threshold value to determine whether and/or when to transfer the user to human agent(s). Alternatively, in some embodiments, the overall risk score may be calculated by machine learning models without first calculating the conversation risk score and the goal risk score(s).

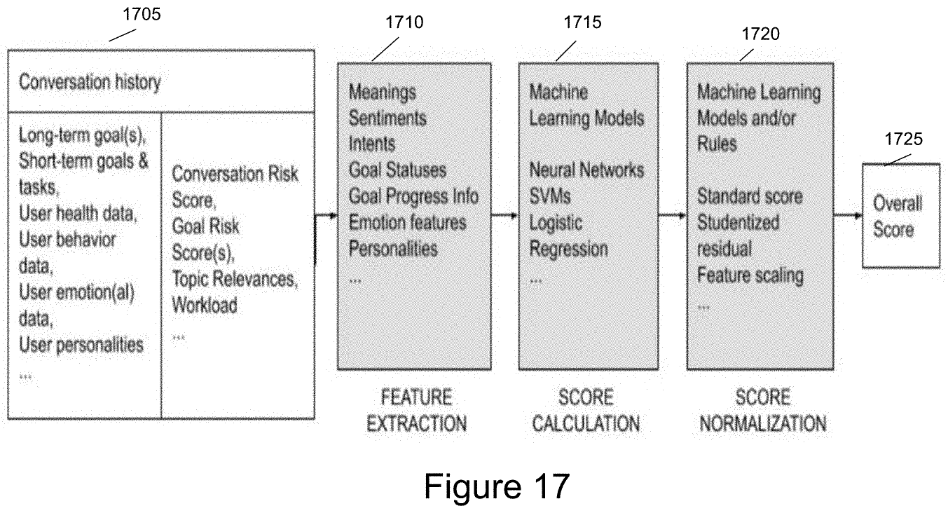

FIG. 17 shows a method and process of using conversation history data, goal-related data, user data and the workload of the platform together as input data 1705 for machine learning models. The input data is used to extract or identify features such as conversation meaning, intents, sentiments, goal achievement status and progress, behavior change progress, user's emotion(s) and personalities etc. in a Feature Extraction Module 1710. The features are provided as input to the Score Calculation Module 1715 wherein previously trained machine learning models are used to calculate at least one score. The score(s) is then normalized by machine learning models and/or rules in the Score Normalization Module 1720 to generate a normalized overall risk score.

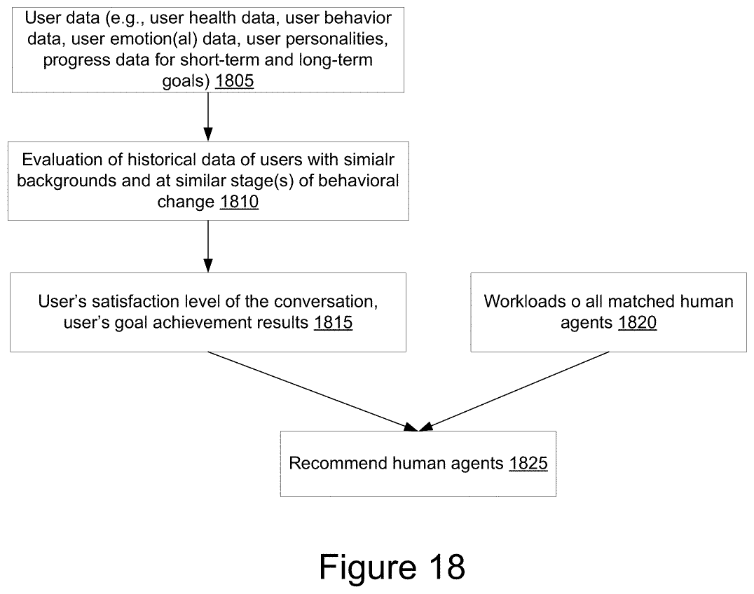

FIG. 18 illustrates a method of selecting a human agent. In some embodiments, at least one human agent is assigned to the user's entire course of a behavior change program. In some other embodiments, the selection of human agent(s) is depicted in the following FIG. 18. In block 1805, user's personal data, health data, behavior change data including progresses towards short-term and long-term goals, with user's emotion status and personalities are used to match a group of users that share similar backgrounds. In block 1810, historical data is evaluated for data associated with all the users in the group at a similar behavior change stage(s) is extracted. In block 1815, the user's satisfaction level of the conversations involved with human coaches and the effectiveness of the human intervention of on the user's advancement towards short-term and long-term goal(s) are used to rank all the human coaches. The workloads of the human coaches is input from block 1820 may also be used as an additional factor to match and recommend at least one human agent in block 1825.

A general training pipeline for the machine learning models mentioned in this patent application are described next in greater detail, unless otherwise specified for a specific model. The pipeline has four major parts, functions, operations, or modules (wherein each module may be implemented by a set of computer-executable instructions stored in or on a non-transitory computer-readable medium and that are executed by a programmed processor):

a data collection module that prepares the training data for the models;

a feature extraction module that extracts relevant features from the raw data;

a model training module that runs the extracted features and labels through the machine learning algorithms; and

a post processing module that takes the outputs from the trained models, and converts that output to task-specific outputs.

The data collection module collects two different kinds of data: (a) unannotated or annotated but task-irrelevant data which can be fetched from websites, and can be used for pre-training; and (b) annotated, task-specific data, which is collected from users through the system/platform described herein, and which is manually annotated to serve the goals of a specific task.

The feature extraction module extracts relevant task specific features from the data, including, but not limited to, one or more of raw data itself, meanings, sentiments, goal status, goal progress, etc.

The model training module inputs the labeled/unlabeled features to a set of one or more machine learning algorithms, including, but not limited to, neural networks, decision tree, support vector machine, logistic regression, etc. Efforts will be made to make the training efficient and accurate.

Lastly, the post processing module takes the raw outputs from the trained models, and converts them into task-specific outputs. Techniques that can be used in this module include, but not limited to normalization, weighted combination, application of machine generated or human-made rules, etc.

Information and data from the conversations between the user and the AI agent and human agents, such as conversation content, coaching topics, emotional status, as well as the user's behavior change data may be collected and analyzed to generate a report that shows the past performance and/or future predicted likelihoods of success in behavior changes, such as the historical performance of the user's behavior change, the trend and predicted likelihood of success in achieving one or more long-term goals, the correlations between the conversation data and the user's behavior change progress data, the total length of time associated with human agent engagements, and the total length of time the user interacts with the AI agent. Such reports may be automatically generated at certain time intervals and securely transmitted electronically to one or more healthcare providers and insurance companies(plans).

The amount of time human agents spend with the user may be tracked by the system. The amount of time human agents spend with the user may further comprise of chatting time, data viewing time and analysis time. The chatting time may be tracked by the length of time when the human agent is texting, speaking or video chatting. The data viewing and analysis time may be tracked by the duration when the human agent interacts with the historical conversation data, the user's historical behavior change data and the statistics and summary data from conversations and/or behavior change data. The duration of interactions may be determined by screen scrolling actions, or information from hardware that supports facial recognition and tracking, and may be further processed by algorithms to improve accuracy.

Each application module or sub-module may correspond to a particular function, method, process, or operation that is implemented by the module or sub-module. Such function, method, process, or operation may include those used to implement one or more aspects of the inventive system and methods, such as for:

Receive conversation data from one or more of a text message, audio, emoji, picture, or animation input;

Convert non text-based messages to text-based messages;

Process the message by natural language processing (NLP) and natural language understanding unit (NLU), including sentiment analysis;

Retrieve and/or store data in databases;

Compute and compare the risk levels for both conversation risk and the risk to the user's achievement of a long term goal; and

Execute a decision to transfer a communication session to another AI agent or to human agent(s) based on evaluation of a combined risk score.

In some embodiments, certain of the methods, models or functions described herein may be embodied in the form of a trained neural network, where the network is implemented by the execution of a set of computer-executable instructions. The instructions may be stored in (or on) a non-transitory computer-readable medium and executed by a programmed processor or processing element. The specific form of the method, model or function may be used to define one or more of the operations, functions, processes, or methods used in the development or operation of a neural network, the application of a machine learning technique or techniques, or the development or implementation of an appropriate decision process. Note that a neural network or deep learning model may be characterized in the form of a data structure in which are stored data representing a set of layers containing nodes, and connections between nodes in different layers are created (or formed) that operate on an input to provide a decision or value as an output.

In general terms, a neural network may be viewed as a system of interconnected artificial “neurons” that exchange messages between each other. The connections have numeric weights that are “tuned” during a training process, so that a properly trained network will respond correctly when presented with an image or pattern to recognize (for example). In this characterization, the network consists of multiple layers of feature-detecting “neurons”; each layer has neurons that respond to different combinations of inputs from the previous layers. Training of a network is performed using a “labeled” dataset of inputs in a wide assortment of representative input patterns that are associated with their intended output response. Training uses general-purpose methods to iteratively determine the weights for intermediate and final feature neurons. In terms of a computational model, each neuron calculates the dot product of inputs and weights, adds the bias, and applies a non-linear trigger or activation function (for example, using a sigmoid response function).

Any of the software components, processes or functions described in this application may be implemented as software code to be executed by a processor using any suitable computer language such as, for example, Java, JavaScript, C++ or Perl using, for example, conventional or object-oriented techniques. The software code may be stored as a series of instructions or commands in (or on) a non-transitory computer-readable medium, such as a random-access memory (RAM), a read only memory (ROM), a magnetic medium such as a hard-drive or a floppy disk, or an optical medium such as a CD-ROM. In this context, a non-transitory computer-readable medium is almost any medium suitable for the storage of data or an instruction set aside from a transitory waveform. Any such computer readable medium may reside on or within a single computational apparatus, and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium may include almost any structure, technology or method apart from a transitory waveform or similar medium.

Certain implementations of the disclosed technology are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, can be implemented by computer-executable program instructions. Note that in some embodiments, one or more of the blocks, or stages or steps may not necessarily need to be performed in the order presented, or may not necessarily need to be performed at all.

These computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, or methods described herein. These computer program instructions may also be stored in a computer-readable memory that can direct a computer or other programmable data processing apparatus to function in a specific manner, such that the instructions stored in the computer-readable memory produce an article of manufacture including instruction means that implement one or more of the functions, operations, processes, or methods described herein.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

The present disclosure describes Reference in the specification to “one embodiment”, “some embodiments” or “an embodiment” means that a particular feature, structure, or characteristic described in connection with the embodiment is included in at least some embodiments of the disclosed technologies. The appearances of the phrase “in some embodiments” in various places in the specification are not necessarily all referring to the same embodiment.

Some portions of the detailed descriptions above were presented in terms of processes and symbolic representations of operations on data bits within a computer memory. A process can generally be considered a self-consistent sequence of steps leading to a result. The steps may involve physical manipulations of physical quantities. These quantities take the form of electrical or magnetic signals capable of being stored, transferred, combined, compared, and otherwise manipulated. These signals may be referred to as being in the form of bits, values, elements, symbols, characters, terms, numbers, or the like.

These and similar terms can be associated with the appropriate physical quantities and can be considered labels applied to these quantities. Unless specifically stated otherwise as apparent from the prior discussion, it is appreciated that throughout the description, discussions utilizing terms, for example, “processing” or “computing” or “calculating” or “determining” or “displaying” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The disclosed technologies may also relate to an apparatus for performing the operations herein. This apparatus may be specially constructed for the required purposes, or it may include a general-purpose computer selectively activated or reconfigured by a computer program stored in the computer. The disclosed technologies can take the form of an implementation containing both software and hardware elements. In some implementations, the technology is implemented in software, which includes, but is not limited to, firmware, resident software, microcode, etc.

Furthermore, the disclosed technologies can take the form of a computer program product accessible from a non-transitory computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A computing system or data processing system suitable for storing and/or executing program code will include at least one processor (e.g., a hardware processor) coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

Finally, the processes and displays presented herein may not be inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the disclosed technologies were not described with reference to any particular programming language. It will be appreciated that a variety of programming languages may be used to implement the teachings of the technologies as described herein.

What is claimed is:

1. A computer-implemented system, comprising:
Artificial Intelligence (AI) agents trained to provide behavioral modification coaching sessions that include interactive coaching conversations with a human user;
a sensing system configured to monitor coaching conversations conducted by AI agents and evaluate risk factors related to maintaining a quality of the coaching sessions within a pre-selected range of quality; and
a decision system to receive the evaluated risk factors and schedule a human agent coach to handle a conversation session in response to detecting a quality of a coaching session falling below the pre-selected range of quality.

2. The system of claim 1, wherein the decision system draws in a human agent by scheduling a transfer of a conversation session from an AI agent to a human agent coach.

3. The system of claim 1, wherein the decision system draws in a human agent by drawing in a human agent to collaborate with an AI agent to handle the conversation session.

4. The system of claim 1, wherein the sensing system comprises a trained machine learning model to determine one or more risk scores based on extracted features of a conversation.

5. The system of claim 4, wherein the overall risk score is determined by extracting features from the conversation session and using a trained machine learning model to generate an overall risk score.

6. The method of claim 5, wherein extracting features comprises extracting one or more of meanings, sentiments, goal statuses, goal progress, emotion features, and personalities.

7. The system of claim 1, wherein the decision system further includes a mode of operation to the conversation to a different AI agent.

8. The system of claim 1, wherein the decision system draws in a human agent to maintain at least one of a user coaching experience, a short term coaching goal objective, and a long term coaching goal objection.

9. A computer-implemented method comprising:
receiving a request of a user for behavioral coaching for a long term goal;
servicing interactive coaching conversations for the user with a combination of Artificial Intelligence (AI) agents trained to provide coaching services and human agents trained to provide coaching services;
assigning an interactive coaching conversation of a user to a first AI agent;
monitoring coaching conversations conducted by the first AI agent and calculating an overall risk score indicative of a likelihood the coaching conversation session conducted by the first AI agent will fail to advance at least one coaching goal;
in response to determining that the coaching conversation conducted by the first AI agent has an overall risk score indication that it will fail, initiating a mode of operation in which a different agent handles the coaching conversation session.

10. The method of claim 9, wherein the mode of operation comprises transferring the conversation session from the first AI to the human agent.

11. The method of claim 9, wherein the mode of operation comprises a collaborate mode of operation between a human agent and the first AI agent.

12. The method of claim 9, wherein the mode of operation comprises transferring the conversation session from the first AI agent to a second AI agent.

13. The method of claim 9, wherein the mode of operation is initiating to maintain at least one of a user coaching experience, a short term coaching goal objective, and a long term coaching goal objection within a quality tier.

14. The method of claim 9, wherein the overall risk score is determined by extracting features from the conversation session and using a trained machine learning model to generate an overall risk score.

15. The method of claim 14, wherein extracting features comprises extracting one or more of meanings, sentiments, goal statuses, goal progress, emotion features, and personalities.

16. A computer-implemented method comprising:
receiving a request of a user for behavioral coaching for a long term goal divisible into a sequence of short-term goals;
providing a series of interactive coaching sessions for the user selected to implement the short term goals and the long term goal, each interactive coaching session including an interactive conversation with the user, including:
servicing the series of interactive coaching sessions with a combination of Artificial Intelligence (AI) agents and human agents;
monitoring user progress towards short term goals and the long term goal;
monitoring user satisfaction;
performing, for at least one interactive coaching session, an initial matching of the user with an AI agent;
monitoring coaching conversations services by an AI agent for the at least one interactive coaching session;
determining an overall risk score indicative of a likelihood the coaching conversation session conducted by the AI agent will fail to advance at least one of user satisfaction and a short term goal; and
in response to determining that the coaching conversation conducted by the AI agent has an overall risk score exceeding a threshold level, initiating a mode of operation in which a human agent handles the coaching conversation session.

17. The method of claim 16, wherein the overall risk score includes a contribution from a conversation risk score and a goal risk score.

18. The method of claim 17, wherein a workload of a human agents and a number of user's is used in addition to the overall risk score to determine whether a human agent handles a conversation.

19. The method of claim 17, wherein the goal risk score includes an achievement risk for a short term goal and an effect on a long term goal.

20. The method of claim 17, wherein a conversation history is analyzed to determine the conversation risk score.
